(19) United States
(12) Patent Application Publication
(10) Pub. No.: US 2025/0217967 A1
(43) Pub. Date: Jul. 3, 2025

(54) METHOD AND APPARATUS WITH IMAGE ANOMALY DETECTION

(71) Applicant: Samsung Electronics Co., Ltd., Suwon-si (KR)

(72) Inventors: Jiwhan KIM, Suwon-si (KR); Sucheol LEE, Suwon-si (KR); Seonghui MO, Suwon-si (KR); Minsu AHN, Suwon-si (KR); Donghyun LEE, Suwon-si (KR); Hyun LEE, Suwon-si (KR); Jaeyeong JEONG, Suwon-si (KR); Young-Seok KIM, Suwon-si (KR); Sungjoo SUH, Suwon-si (KR)

(73) Assignee: Samsung Electronics Co., Ltd., Suwon-si (KR)

(21) Appl. No.: 19/007,949

(22) Filed: Jan. 2, 2025

(30) Foreign Application Priority Data
Jan. 3, 2024 (KR) 10-2024-0001165

(51) Int. Cl. G06T 7/00

(52) U.S. Cl. CPC G06T 7/001; G06T 2207/20084; G06T 2207/30204

(57) ABSTRACT

A processor-implemented method includes generating an image feature of an input image and a marker feature of a marker marked on the input image, determining a comparison result of the image feature by comparing the image feature of the input image with a reference image feature of one or more reference images, determining a comparison result of the marker feature by comparing the marker feature with a reference marker feature of a reference marker on the one or more reference images, and detecting whether an anomaly is in the input image based on the comparison result of the image feature and the comparison result of the marker feature.

### CROSS-REFERENCE TO RELATED APPLICATIONS

This application claims priority to and the benefit under 35 USC § 119 (a) of Korean Patent Application No. 10-2024-0001165 filed in the Korean Intellectual Property Office on Jan. 3, 2024, the entire disclosure of which is incorporated herein by reference for all purposes.

### BACKGROUND

### 1. Field

The following description relates to a method and apparatus with image anomaly detection.

### 2. Description of Related Art

The degree of distortion of an image may be used to detect an anomaly in the image. For example, the blurring, noise, and contrast levels of the image may be measured, and the anomaly may be detected in the image when the measurements deviate from the reference value.

Methods for generating image characteristics and detecting image anomalies may use a convolutional neural network (CNN). However, the training of the CNN may require a dataset consisting of training images and the ground truth quality scores of the training images, so CNN training on unlabeled data may be difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating an image feature of an input image and a marker feature of a marker marked on the input image, determining a comparison result of the image feature by comparing the image feature of the input image with a reference image feature of one or more reference images, determining a comparison result of the marker feature by comparing the marker feature with a reference marker feature of a reference marker on the one or more reference images, and detecting whether an anomaly is in the input image based on the comparison result of the image feature and the comparison result of the marker feature.

The generating of the image feature of the input image and the marker feature of the marker marked on the input image may include generating a measurement image by removing the marker from the input image, and generating a feature map of the measurement image by using an artificial intelligence (AI) model.

The generating of the image feature of the input image and the marker feature of the marker marked on the input image further may include obtaining patch information of a marker patch of a plurality of patches in the input image, and the market patch may include the marker.

The comparing of the image feature of the input image with the reference image feature of the one or more reference images may include determining one or more map similarities between the feature map of the measurement image and a reference feature map of the one or more reference images, and determining a greatest map similarity among the one or more map similarity as a normal image score of the input image.

The comparing of the marker feature with the reference marker feature of the reference marker of the one or more reference images may include determining one or more patch similarities between the marker patch of the measurement image and a reference marker patch of the one or more reference images, and determining a greatest patch similarity among the one or more patch similarities as a normal marker score of the marker.

The detecting of whether the anomaly is in the input image based on the comparison result of the image feature and the comparison result of the marker feature may include either one of determining the input image as being normal in response to the normal image score satisfying a first condition based on the one or more map similarities and the normal marker score satisfying a second condition based on the one or more patch similarities, and determining the input image as being abnormal in response to the normal image score not satisfying the first condition based on the one or more map similarities or the normal marker score not satisfying the second condition based on the one or more patch similarities.

The method may include generating the reference image feature of the one or more reference images and the reference marker feature of the reference marker of the one or more reference images.

The generating of the reference image feature of the one or more reference images and the reference marker feature of the reference marker of the one or more reference images may include generating a feature map of the one or more reference images from which the reference marker is removed by using an artificial intelligence (AI) model, and obtaining patch information of a marker patch including the reference marker in the one or more reference image.

The method may include generating a measurement image by removing the marker from the input image, for the determining of the comparison result of the image feature, determining a map similarity between a feature map of the measurement image and a reference feature map of the one or more reference images, for the determining of the comparison result of the marker feature, determining a patch similarity between a marker patch of a plurality of patches in the measurement image and a reference marker patch of a plurality of patches in the one or more reference images, and for the detecting of whether the anomaly is in the input image, determining the anomaly is not present in the input image in response to the map similarity being greater than or equal to a reference value and the patch similarity being greater than or equal to another reference value.

In one or more general aspects, an apparatus includes one or more processors configured to generate an image feature of an input image and a marker feature of a marker marked on the input image, determine a comparison result of the image feature by comparing the image feature of the input image with a reference image feature of one or more reference images, determine a comparison result of the marker feature by comparing the marker feature with a reference marker feature of a reference marker on the one or more reference images, and detect whether an anomaly is in the input image based on the comparison result of the image feature and the comparison result of the marker feature.

For the generating of the image feature of the input image and the marker feature of the marker marked on the input image, the one or more processors may be configured to generate a measurement image by removing the marker from the input image, and generate a feature map of the measurement image by using an artificial intelligence (AI) model.

For the generating of the image feature of the input image and the marker feature of the marker marked on the input image further, the one or more processors may be configured to obtain patch information of a marker patch of a plurality of patches in the input image, and the marker patch may include the marker.

For the comparing of the image feature of the input image with the reference image feature of the one or more reference images, the one or more processors may be configured to determine one or more map similarity between the feature map of the measurement image and a reference feature map of the one or more reference images, and determine a greatest map similarity among the one or more map similarities as a normal image score of the input image.

For the comparing of the marker feature with the reference marker feature of the reference marker of the one or more reference images, the one or more processors may be configured to determine one or more patch similarity between the marker patch of the measurement image and a reference marker patch of the one or more reference images, and determine a greatest patch similarity among the one or more patch similarities as a normal marker score of the marker.

For the detecting of whether the anomaly is in the input image based on the comparison result of the image feature and the comparison result of the marker feature, the one or more processors may be configured to perform either one of determining the input image as being normal in response to the normal image score satisfying a first condition based on the one or more map similarities and the normal marker score satisfying a second condition based on the least one patch similarity, and determining the input image as being abnormal in response to the normal image score not satisfying the first condition based on the one or more map similarities or the normal marker score not satisfying the second condition based on the one or more patch similarities.

For the generating of the reference image feature of the one or more reference images and the reference marker feature of the reference marker of the one or more reference images, the one or more processors may be configured to generate a feature map of the one or more reference images from which the reference marker is removed by using an artificial intelligence (AI) model, and obtain patch information of a marker patch including the reference marker in the one or more reference images.

In one or more general aspects, a measurement system of a semiconductor manufacturing process includes a measurement device configured to obtain a measurement image of an in-fabrication wafer and display a marker on the measurement image, and an image inspection device configured to detect an anomaly in an input image by using an image feature and a marker feature of the input image by using an artificial intelligence (AI) model, wherein the input image includes the measurement image and the marker and is input to the AI model from the measurement device.

The image inspection device may be configured to compare the image feature and the marker feature of the input image with a reference image feature and a reference marker feature of a reference image, and detect the anomaly in the input image based on comparison results.

The image inspection device may be configured to reconstruct the measurement image by removing the marker from the input image, and use a feature map of the reconstructed measurement image output by the AI model as the image feature.

The image inspection device may be configured to detect the marker within the input image, and use patch information of a marker patch of a plurality of patches as the marker feature, and the marker may be located in the marker patch.

Other features and aspects will be apparent from the following detailed description, the drawings, and the claims.

### BRIEF DESCRIPTION OF THE DRAWINGS

FIG. 1 illustrates an image inspection apparatus according to one or more embodiments.

FIG. 2 illustrates a measurement image and a marked measurement image according to one or more embodiments.

FIG. 3 illustrates an image inspection method according to one or more embodiments.

FIG. 4 illustrates a method for generating image feature and marker feature according to one or more embodiments.

FIG. 5 to FIG. 7 illustrate a measurement image and a marker separated from an input image according to one or more embodiments.

FIG. 8 illustrates a patch of a measurement image including a normal marker and abnormal marker according to one or more embodiments.

FIG. 9 illustrates an image inspection method in a manufacturing process of a semiconductor according to one or more embodiments.

FIG. 10 illustrates an AI model structure according to one or more embodiments.

FIG. 11 illustrates an image inspection apparatus according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

In the flowcharts described with reference to the drawings in this specification, the operation order may be changed, various operations may be merged, certain operations may be divided, and certain operations may not be performed.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

An Artificial Intelligence (AI) model of the present disclosure is a machine learning model for learning at least one task, which may be implemented as a computer program executed by a processor. The task learned by the AI model may refer to the task to be solved through machine learning, or the task to be performed through machine learning. The AI model may be implemented as a computer program executed on a computing device, may be downloaded through a network, or may be sold as a product. Alternatively, the AI model may be interlocked with a variety of devices through the network.

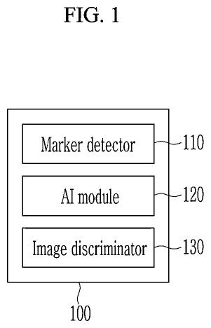

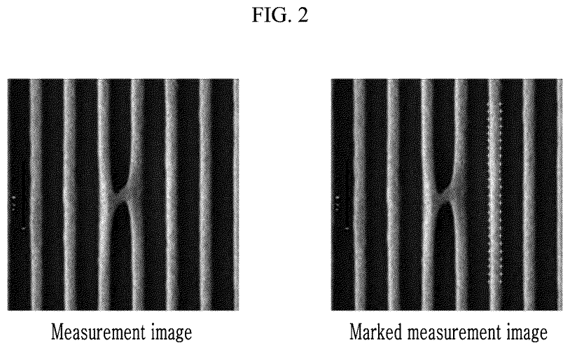

FIG. 1 illustrates an image inspection apparatus according to one or more embodiments. FIG. 2 illustrates a measurement image of a semiconductor and a marked measurement image according to one or more embodiments.

In one or more embodiments, a measurement device such as a critical dimension (CD)-scanning electron microscope (SEM) may photograph a measurement image of a semiconductor wafer in an in-fabrication environment and determine whether processes (e.g., the processes used to fabricate the semiconductor wafer) are normally processed based on the measurement image. For example, the measurement device may photograph fine patterns from a semiconductor wafer on which a partial process (e.g., a photo masking process, an etching process, or the like) for a semiconductor has been completed to generate the measurement image. In such embodiments, the measurement device may measure size, length, and distance and/or the like of the fine patterns in the measurement image. The size, length, and distance and/or the like of the measured fine patterns may be used for confirming a target margin between processes, analysis of cause of defects, and/or the like during the manufacturing process of the semiconductor. A marker for the measurement may be included in the measurement image generated by the measurement device.

Referring to FIG. 1, an image inspection apparatus 100 according to one or more embodiments may include a marker detector 110, an AI module 120, and an image discriminator 130. When an image is input from the measurement device, the image inspection apparatus 100 may determine whether the image is normal (e.g., an anomaly is not present in the input image) or abnormal (e.g., an anomaly is present in the input image). A marker may be marked to the image and be included in the image by the measurement device and/or by the marker detector 110.

In one or more embodiments, the marker detector 110 may detect the marker from the input image, and, by removing the detected marker from the input image, may reconstruct the measurement image from the input image. The marker detector 110 may generate a marker image based on the detected marker. When the measurement image is photographed by the measurement device (e.g., the SEM or the like), the measurement device may mark the marker on the measurement image and, by using the marker, may perform measurement of the CD or the like. Referring to FIG. 2, a white cross-shaped marker is marked on the measurement image including fine patterns of the semiconductor wafer.

In one or more embodiments, a reference image for image determination may be transferred to the image inspection device 100 from measurement equipment and/or a database. When a reference marker is marked on the reference image, the marker detector 110 may detect the reference marker in the reference image and remove the detected reference marker from the reference image. The reference image may include information regarding process steps. When there is a process change, addition or change of equipment, etc., the reference image may be transmitted from the measurement device and/or the database to the image inspection device 100. The reference image is a normally photographed measurement image and the reference marker is correctly marked at a correct position in the reference image.

In one or more embodiments, the marker detector 110 may obtain patch information of a marker patch of a plurality of patches in the measurement image. The marker is located in the marker patch. The marker detector 110 may also obtain the patch information of a reference marker patch of a plurality of patches in the reference image. The reference marker is located in the reference marker patch.

In one or more embodiments, an AI model of (e.g., implemented by) the AI module 120 may generate a feature map from the measurement image. The AI model may be trained through a self-supervised learning (e.g., contrastive learning), and the trained AI model may output a feature map from the input image. In addition, the AI model may generate a feature map from the reference image.

In one or more embodiments, images of a plurality of classes without labels may be used as training dataset for the AI model. The training dataset may be generated through data augmentation on the images without labels, and the AI model may learn quality features of the images by using the augmented training data. For example, the data augmentation can be performed according to the distortion characteristics expected to be exhibited by an abnormal measurement image, such as adding noise, blurring, brightness adjustment, and contrast adjustment to the measurement image of the semiconductor wafer. In one or more embodiments, the trained AI model may map the image having the same class and/or the same distortion to a feature map having higher similarity.

In one or more embodiments, the image discriminator 130 may determine a map similarity between a feature map of the measurement image and a reference feature map of the reference image transmitted by the trained AI model. In addition, the image discriminator 130 may determine a patch similarity between the marker patch of the measurement image and the reference marker patch of the reference image based on the patch information of the marker patch of the measurement image and the patch information of the reference marker patch of the reference image.

Alternatively or additionally, the image discriminator 130 may determine a global similarity between the marker image of the measurement image and the reference marker image of the reference image.

Thereafter, the image discriminator 130 may determine normality/anomaly of the measurement image based on the map similarity between the feature map of the measurement image and the reference feature map of the reference image and the patch similarity between the marker patch of the measurement image and the reference marker patch of the reference image. In one or more embodiments, when the map similarity satisfies (e.g., is greater than or equal to) a reference value of the map similarity and the patch similarity satisfies (e.g., is greater than or equal to) a reference value of the patch similarity, the image discriminator 130 may determine the measurement image as being normal. In addition, when the map similarity does not satisfy (e.g., is less than) the reference value of the map similarity or the patch similarity does not satisfy (e.g., is less than) the reference value of the patch similarity, the image discriminator 130 may determine the measurement image as being abnormal.

As such, according to the image inspection apparatus 100 according to one or more embodiments, by using image feature and marker feature of the input image transferred from the measurement device in an in-fabrication environment, the image inspection apparatus 100 of one or more embodiments may accurately detect the anomaly of the measurement image and/or anomaly of the marker marked on the input image.

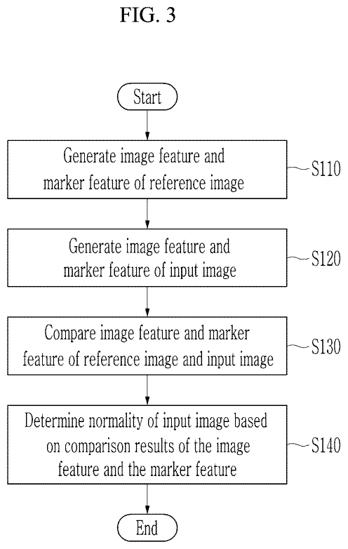

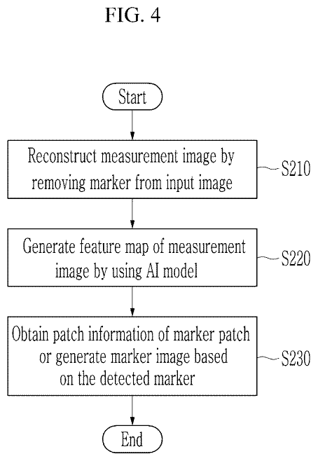

FIG. 3 illustrates an image inspection method according to one or more embodiments. FIG. 4 illustrates a method for generating an image feature and a marker feature according to one or more embodiments. Steps S110 to S140 to be described hereinafter may be performed sequentially in the order and manner as shown and described below with reference to FIG. 3, and steps S210 to S230 to be described hereinafter may be performed sequentially in the order and manner as shown and described below with reference to FIG. 4, but the order of one or more of the respective operations may be changed, one or more of the respective operations may be omitted, and two or more of the respective operations may be performed in parallel or simultaneously without departing from the spirit and scope of the example embodiments described herein.

Referring to FIG. 3, at step S110, the image inspection apparatus 100 may generate an image feature and a marker feature of the reference image, and at step S120, and the image inspection apparatus 100 may generate an image feature and a marker feature of the input image.

In one or more embodiments, the reference image may be transmitted from the measurement device or the database to the image inspection apparatus 100. Further, the marker may be marked on the reference image or the reference image with marker information about the marker may be transmitted to the image inspection apparatus 100. The marker information may be patch information of a marker patch of plurality of patches in the reference image and the marker (e.g., reference marker) may be located in the marker patch. During the semiconductor process, the input image may be transmitted from the measurement device to the image inspection apparatus 100 in the in-fabrication environment.

Referring to FIG. 4, at step S210, the image inspection apparatus 100 may detect the marker in the input image and remove the detected marker from the input image to reconstruct a measurement image from the input image. The markers detected in the reference image and the input image may be used to generate a marker image.

Thereafter, at step S220, the image inspection apparatus 100 may generate a feature map of the measurement image by using the AI model. The AI model may be trained to output a reference feature map from a plurality of reference images and output a feature map from the measurement image. The image inspection apparatus 100 may use the reference feature maps generated from the references image as the image feature of the reference images, and use the feature map generated from the measurement image as the image feature of the input image.

In one or more embodiments, the image inspection apparatus 100 may use patch information of a reference marker patch of a plurality of patches in the reference images as the marker feature of the reference images and the reference marker is located in the reference marker patch. In addition, the image inspection apparatus 100 may use patch information of the marker patch of a plurality of patches in the input image as the marker feature of the input image and the marker is located in the marker patch. Alternatively or additionally, at step S230, the image inspection apparatus 100 may use the marker image of the reference image as the reference marker feature and the marker image of the input image as the marker features.

Referring back to FIG. 3, at step S130, the image inspection apparatus 100 may compare the image feature and the marker feature of the input image with the reference image feature and the reference marker feature of the reference image, and at step S140, may detect an anomaly in the input image based on comparison results of the image feature and the marker feature with the reference image feature and the reference marker feature.

In one or more embodiments, the image inspection apparatus 100 may determine map similarity between the feature map of the measurement image and reference feature map of an at least one reference image, and may determine a greatest map similarity as a normal image score of the measurement image (or input image).

In addition, In one or more embodiments, the image inspection apparatus 100 may determine patch similarity between the marker patch of the measurement image and the reference marker patch of the at least one reference image, and may determine a greatest patch similarity as a normal marker score of the marker. Alternatively, In one or more embodiments, the image inspection apparatus 100 may determine global similarity between the marker image of the measurement image and the reference marker image of the at least one reference image, and may determine a greatest global similarity as the normal marker score of the marker in the input image.

In one or more embodiments, when the normal image score of the measurement image satisfies (e.g., is greater than or equal to) a predetermined first reference value and the normal marker score of the marker satisfies (e.g., is greater than or equal to) a predetermined second reference value, the image inspection apparatus 100 may determine the input image as being normal.

The predetermined first reference value regarding the normal image score of the measurement image may be adaptively determined based on an average similarity between a plurality of feature maps generated from the plurality of reference images. Alternatively, the predetermined first reference value may be selected as a particular value depending on the semiconductor manufacturing process.

In one or more embodiments, the predetermined second reference value regarding the normal marker score of the marker may be adaptively determined based on an average similarity between the marker patches in the plurality of reference images or may be adaptively determined based on an average similarity between the marker images of the plurality of reference images. Alternatively, the predetermined second reference value may be selected as a particular value depending on the semiconductor manufacturing process.

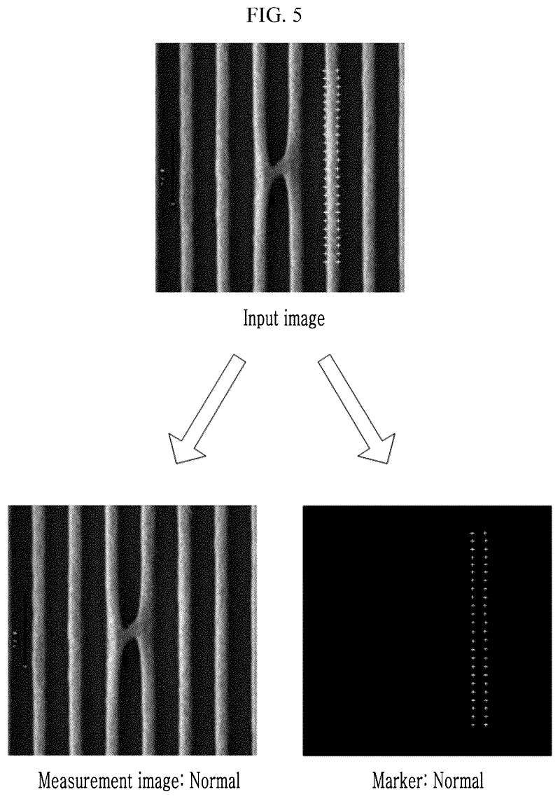

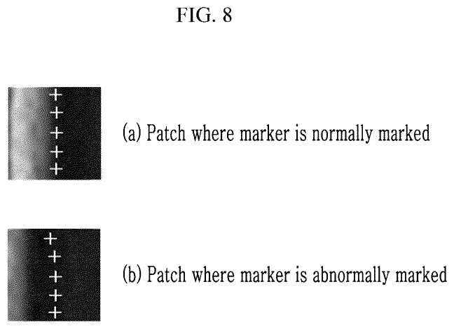

FIG. 5 to FIG. 7 illustrate a measurement image and a marker separated from an input image according to one or more embodiments. FIG. 8 illustrates a patch in a measurement image including a normal marker and an abnormal marker according to one or more embodiments.

Referring to FIG. 5, an input image where a marker is normally marked in the normal measurement image is shown.

A feature map generated from the normal measurement image may show high similarity to the feature maps of the plurality of reference images, and accordingly, a normal image score of the normal measurement image may satisfy a first condition (e.g., the normal image score is greater than or equal to a predetermined first reference value). In addition, a marker patch including the normal marker may show high similarity to the reference marker patches including the reference markers of the plurality of reference images, and accordingly, the normal marker score of the normal marker may satisfy a second condition (e.g., the normal marker score is greater than or equal to a predetermined second reference value). Alternatively, a marker image of the normal marker may show high similarity to the reference marker images of the plurality of reference images, and therefore, the normal marker score of the normal marker may satisfy the second condition (e.g., the normal marker score is greater than or equal to the predetermined second reference value).

However, when the normal image score of the measurement image does not satisfy the first condition (e.g., the normal image score is less than the predetermined first reference value) and/or the normal marker score of the marker does not satisfy the second condition (e.g., the normal marker score is less than the predetermined second reference value), the image inspection apparatus 100 may determine the input image as being abnormal.

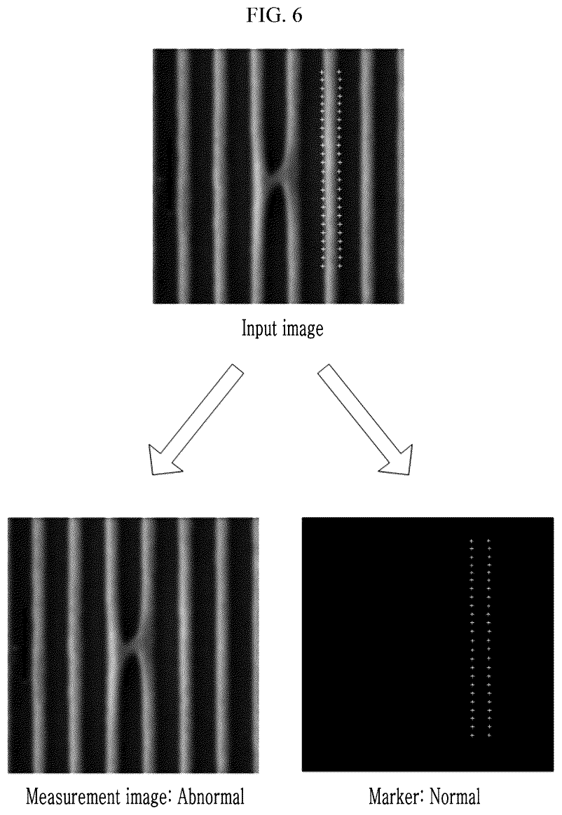

Referring to FIG. 6, the normal marker is marked in the abnormal measurement image (e.g., blurred measurement image). When the measurement image is an abnormal image, the normal image score of the measurement image may be lower than the predetermined first reference value. In addition, when there is distortion in the marker patch or marker image of the marker, the marker patch or marker image of the measurement image may exhibit relatively low similarity to the marker patches or marker images of the plurality of reference images.

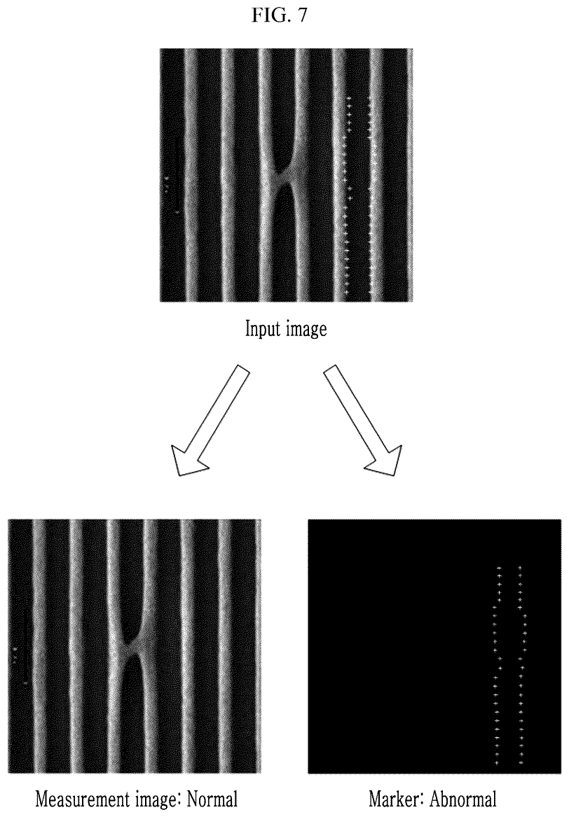

Referring to FIG. 7, a marker is abnormally marked in the normal measurement image. Although the feature map generated from the normal measurement image may show high similarity to the feature maps of the plurality of reference images, when the marker is abnormally marked on the measurement image, the normal marker score of the marker may be lower than the predetermined second reference value.

Referring to FIG. 8, an enlarged view of the marker patch included in the measurement image is shown. Image (a) may represent a case where the marker is well marked on the boundary of an object in the measurement image. Image (b) may represent a case where the marker is not properly marked on the boundary of an object in the measurement image. Image (a) may represent a patch including 5 markers from the top of the input image of FIG. 5, and image (b) may represent a patch including 5 markers from the top of the input image of FIG. 7. In FIG. 8, the white cross indicating the marker is arbitrarily drawn to indicate that it is the marker patch.

In one or more embodiments, even when the measurement image is well photographed by the measurement device, the measurement device may not mark the marker at the correct position, and/or when the boundary is not clear due to distortion of the measurement image, the measurement device may not accurately determine the correct position where the marker is to be marked.

By determining whether a normal marker score of marker of the measurement image exceeds the reference value, the image inspection apparatus 100 of one or more embodiments may detect the anomaly in the input image, considering not only the case where distortion has occurred in the measurement image but also whether the marker on the measurement image is abnormal. For example, referring to FIG. 8, when image (a) is the reference marker patch of the reference image and image (b) is the marker patch of the measurement image, the patch similarity between the two marker patches may be relatively low, and the normal marker score of the marker determined from the patch similarity may be lower than the predetermined second the reference value.

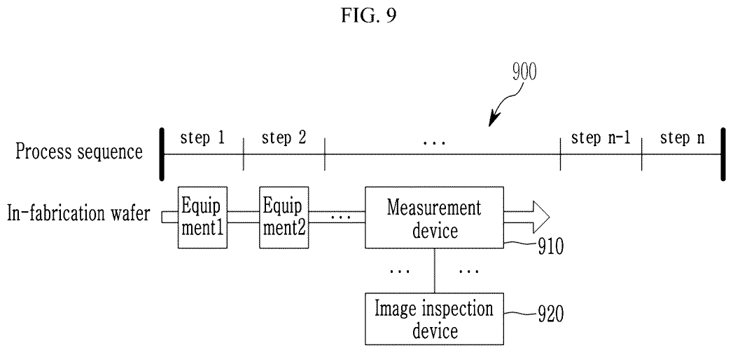

FIG. 9 illustrates a measurement system of a manufacturing process of a semiconductor according to one or more embodiments.

Referring to FIG. 9, a measurement system 900 of a semiconductor manufacturing process may include the measurement device 910 and image inspection device 920.

When an in-fabrication wafer is processed by respective process equipment according to the process sequence, the measurement device 910 in the process sequence may obtain the measurement image of the in-fabrication wafer. The measurement device 910 may mark a marker on the measurement image, and, by using the marker, may perform the measurement for inspecting progress status of the process.

When the measurement image with a marker transmitted from the measurement device 910 is input, the image inspection device 920 according to one or more embodiments may detect an anomaly of the input image (that is, measurement image with a marker). The anomaly in the input image may occur in the measurement image or in the marker on the measurement image.

The image inspection device 920 according to one or more embodiments may generate an image feature of the input image and compare the generated image feature with the reference image features of the reference image, and thereby may detect the anomaly occurring in the measurement image obtained by the measurement device 910. In addition, the image inspection device 920 may generate a marker feature of the input image and compare the generated marker feature with the reference marker feature of the reference image, and thereby may detect the anomaly occurring in the marker in the measurement image.

In one or more embodiments, the image inspection device 920 may remove the marker from the input image to reconstruct the measurement image from the input image. The image inspection device 920 may use a feature map of the reconstructed measurement image output by an AI model as the image feature of the input image.

In one or more embodiments, the image inspection device 920 may detect the marker within the input image, and use patch information of a marker patch in which marker is located as a marker feature. Alternatively, the image inspection device 920 may detect the marker on the input image, generate the marker image based on the detected marker, and use the generated marker image as the marker feature.

In one or more embodiments, when all of the normal image score of the measurement image and the normal marker score of the marker of the input image exceed the reference values for the normal image score and the normal marker score, the image inspection device 920 may determine the input image as being normal. However, when at least one of the normal image score of the image or the normal marker score of the marker on the input image does not exceed the reference values for the normal image score and the normal marker score, the image inspection device 920 may determine the input image as being abnormal.

In one or more embodiments, the normal image score of the image may be determined based on similarity between the feature map of the measurement image and the reference feature map of the reference image. In addition, the normal marker score of the marker may be determined based on similarity between the marker patch of the input image and the reference marker patch of the reference image or may be determined based on similarity between the marker image from the input image and the reference marker image of the reference image.

In one or more embodiments, when the input image is determined as being abnormal, the measurement device 910 may not perform the measurement based on the corresponding input image. For example, when the normal image score of the input image is less than a first reference value, it may be considered that an error or a malfunction has occurred at an image sensor of the measurement device 910, and the image sensor may be repaired or replaced. Alternatively, when the normal marker score of the marker on the input image is less than a second reference value, it may be considered that an error or a malfunction has occurred at a marking equipment or function of the measurement device 910, and the marking equipment or function may be repaired or replaced. Afterwards, when the error of the image sensor and/or marking equipment or function is corrected, the measurement device 910 may re-obtain the image of the in-fabrication wafer, and perform the measurement based on the re-obtained measurement image. The image inspection device 920 according to one or more embodiments may detect the anomaly of the re-obtained image again as needed.

Therefore, an image inspection device of one or more embodiments may detect the anomaly in the input image by using an image feature and a marker feature of the image input from the measurement device, and the error of the measurement device may be confirmed based on the anomaly detection result, thereby decreasing the probability of defects.

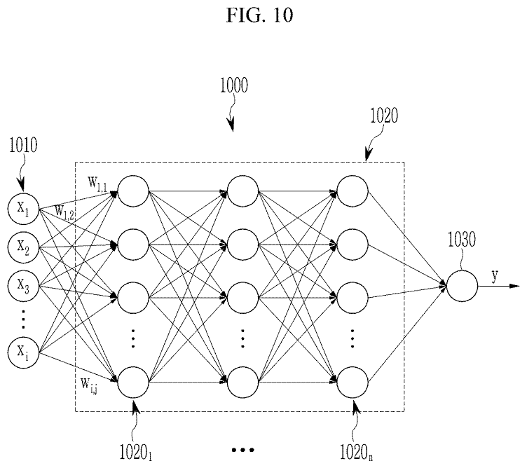

FIG. 10 illustrates an AI model structure according to one or more embodiments.

Referring to FIG. 10, a neural network (NN) 1000 according to one or more embodiments may include an input layer 1010, a hidden layer portion 1020, and an output layer 1030. The input layer 1010, layers in the hidden layer portion 1020, and the output layer 1030 may include respective sets of nodes, and the strength of the connections between the nodes of layers (generally, adjacent, but not necessarily) may be represented as weights (weighted connections). The nodes included in the input layer 1010, the layers in the hidden layer portion 1020, and the output layer 1030 may be fully connected to each other. In one or more embodiments, the number of parameters (e.g., the number of weights and the number of biases) may be equal to the number of weighted connections in the neural network 1000.

The input layer 1010 may include input nodes x₁ to xᵢ, and the number of input nodes x₁ to xᵢ may correspond to the number of independent variables of the input data. A training set may be input to the input layer 1010 for training of the neural network 1000. When test data is input to the input layer 1010 of the trained neural network 1000, an inference result may be output from the output layer 1030 of the trained neural network 1000. In one or more embodiments, the input layer 1010 may have a structure suitable for processing a large-scale input. In a non-limiting example, the neural network 1000 may include a convolutional neural network combined with fully connected layer(s).

The layers of the hidden layer portion 1020 may be located between the input layer 1010 and the output layer 1030 and may include at least one of hidden layers 1020₁ to 1020ₙ. The output layer 1030 may include a node y. An activation function may be used in the layers of the hidden layer portion 1020 and in the output layer 1030. In one or more embodiments, the neural network 1000 may be learned by adjusting weight of the nodes included in the hidden layer portion 1020.

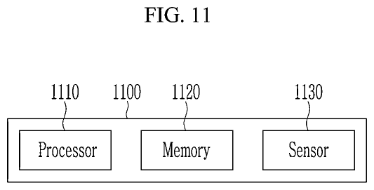

FIG. 11 illustrates an image inspection apparatus according to one or more embodiments.

An image inspection apparatus according to one or more embodiments may be implemented as a computer system.

Referring to FIG. 11, the electronic device 1100 may include a processor (e.g., one or more processors) 1110, a memory 1120 (e.g., one or more memories), and a sensor 1130 (e.g., one or more sensors). The memory 1120 may be connected to the one or more processors 1110 and may store instructions or programs configured to cause the processor 1110 to perform a process including any of the methods described above. For example, the memory 1120 may be or include a non-transitory computer-readable storage medium storing instructions that, when executed by the processor 1110, configure the processor 110 to perform any one, any combination, or all of the operations and/or methods disclosed above with reference to FIGS. 1-10. In an example, the electronic device 1100 may be or include the image inspection apparatus 100 of FIG. 1, and the processor 1110 may include and/or implement the marker detector 110, the AI module 120, and the image discriminator 130 of FIG. 1.

The processor 1110 may realize functions, stages, or methods described for the various embodiments. An operation of the computer system 1100 according to one or more embodiments may be realized by the processor 1110. The processor 1110 may include a GPU, a CPU, and/or an NPU. When the operation of the computer system 1100 is implemented by the processor 1110, each task may be divided among the processor 1110 according to load. For example, when one processor is a CPU, the other processors may be a GPU, an NPU, an FPGA, and/or a DSP.

The memory 1120 may be provided inside/outside the processor, and may be connected to the processor through various means known to a person skilled in the art. The memory represents a volatile or non-volatile storage medium in various forms (but not a signal per se), and for example, the memory may include a read-only memory (ROM) and a random-access memory (RAM). In another way, the memory may be a PIM (processing in memory) including a logic unit for performing self-contained operations (e.g., bit cells may function as both persistent bit storage and may have circuit elements for also performing operations on the stored bit data).

The sensor 1130 may be or include an image sensor (e.g., a camera). The sensor 1130 may generate an input image (e.g., any of the input images discussed above).

In another way, some functions (e.g., training the yield predicting model and/or the path generating model, inference by the yield predicting model and/or the path generating model) of the yield predicting device may be provided by a neuromorphic chip including neurons, synapses, and inter-neuron connection modules. The neuromorphic chip is a computer device simulating biological neural system structures, and may perform neural network operations.

Meanwhile, the embodiments are not only implemented through the device and/or the method described so far, but may also be implemented through a program (instructions) that realizes the function corresponding to the configuration of the embodiment or a recording medium on which the program is recorded, and such implementation may be easily implemented by anyone skilled in the art to which this description belongs from the description provided above. Specifically, methods (e.g., yield predicting methods, etc.) according to the present disclosure may be implemented in the form of program instructions that can be performed through various computer means. The computer readable medium may include program instructions, data files, data structures, etc. alone or in combination. The program instructions recorded on the computer readable medium may be specifically designed and configured for the embodiments. The computer readable recording medium may include a hardware device configured to store and execute program instructions. For example, a computer-readable recording medium includes magnetic media such as hard disks, floppy disks and magnetic tapes, optical recording media such as CD-ROMs and DVDs, and optical disks such as floppy disks. It may be magneto-optical media, ROM, RAM, flash memory, or the like. A program instruction may include not only machine language codes such as generated by a compiler, but also high-level language codes that may be executed by a computer through an interpreter or the like.

The image inspection apparatuses, marker detectors, AI modules, image discriminators, measurement systems, measurement devices, image inspection devices, electronic devices, processors, memories, sensors, image inspection apparatus 100, marker detector 110, AI module 120, image discriminator 130, measurement system 900, measurement device 910, image inspection device 920, electronic device 1100, processor 1110, memory 1120, sensor 1130, and other apparatuses, devices, units, modules, and components described herein, including descriptions with respect to FIGS. 1-11, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-11 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating an image feature of an input image and a marker feature of a marker marked on the input image;
determining a comparison result of the image feature by comparing the image feature of the input image with a reference image feature of one or more reference images;
determining a comparison result of the marker feature by comparing the marker feature with a reference marker feature of a reference marker on the one or more reference images; and
detecting whether an anomaly is in the input image based on the comparison result of the image feature and the comparison result of the marker feature.

2. The method of claim 1, wherein the generating of the image feature of the input image and the marker feature of the marker marked on the input image comprises:
generating a measurement image by removing the marker from the input image; and
generating a feature map of the measurement image by using an artificial intelligence (AI) model.

3. The method of claim 2, wherein
the generating of the image feature of the input image and the marker feature of the marker marked on the input image further comprises obtaining patch information of a marker patch of a plurality of patches in the input image, and
the market patch includes the marker.

4. The method of claim 3, wherein the comparing of the image feature of the input image with the reference image feature of the one or more reference images comprises:
determining one or more map similarities between the feature map of the measurement image and a reference feature map of the one or more reference images; and
determining a greatest map similarity among the one or more map similarity as a normal image score of the input image.

5. The method of claim 4, wherein the comparing of the marker feature with the reference marker feature of the reference marker of the one or more reference images comprises:
determining one or more patch similarities between the marker patch of the measurement image and a reference marker patch of the one or more reference images; and
determining a greatest patch similarity among the one or more patch similarities as a normal marker score of the marker.

6. The method of claim 5, wherein the detecting of whether the anomaly is in the input image based on the comparison result of the image feature and the comparison result of the marker feature comprises either one of:
determining the input image as being normal in response to the normal image score satisfying a first condition based on the one or more map similarities and the normal marker score satisfying a second condition based on the one or more patch similarities; and
determining the input image as being abnormal in response to the normal image score not satisfying the first condition based on the one or more map similarities or the normal marker score not satisfying the second condition based on the one or more patch similarities.

7. The method of claim 1, further comprising generating the reference image feature of the one or more reference images and the reference marker feature of the reference marker of the one or more reference images.

8. The method of claim 7, wherein the generating of the reference image feature of the one or more reference images and the reference marker feature of the reference marker of the one or more reference images comprises:
generating a feature map of the one or more reference images from which the reference marker is removed by using an artificial intelligence (AI) model; and
obtaining patch information of a marker patch including the reference marker in the one or more reference image.

9. The method of claim 1, further comprising:
generating a measurement image by removing the marker from the input image;
for the determining of the comparison result of the image feature, determining a map similarity between a feature map of the measurement image and a reference feature map of the one or more reference images;
for the determining of the comparison result of the marker feature, determining a patch similarity between a marker patch of a plurality of patches in the measurement image and a reference marker patch of a plurality of patches in the one or more reference images; and
for the detecting of whether the anomaly is in the input image, determining the anomaly is not present in the input image in response to the map similarity being greater than or equal to a reference value and the patch similarity being greater than or equal to another reference value.

10. An apparatus comprising:
one or more processors configured to:
generate an image feature of an input image and a marker feature of a marker marked on the input image;
determine a comparison result of the image feature by comparing the image feature of the input image with a reference image feature of one or more reference images;
determine a comparison result of the marker feature by comparing the marker feature with a reference marker feature of a reference marker on the one or more reference images; and
detect whether an anomaly is in the input image based on the comparison result of the image feature and the comparison result of the marker feature.

11. The apparatus of claim 10, wherein, for the generating of the image feature of the input image and the marker feature of the marker marked on the input image, the one or more processors are configured to:
generate a measurement image by removing the marker from the input image; and
generate a feature map of the measurement image by using an artificial intelligence (AI) model.

12. The apparatus of claim 11, wherein
for the generating of the image feature of the input image and the marker feature of the marker marked on the input image further, the one or more processors are configured to obtain patch information of a marker patch of a plurality of patches in the input image, and
the marker patch includes the marker.

13. The apparatus of claim 12, wherein, for the comparing of the image feature of the input image with the reference image feature of the one or more reference images, the one or more processors are configured to:
determine one or more map similarity between the feature map of the measurement image and a reference feature map of the one or more reference images; and
determine a greatest map similarity among the one or more map similarities as a normal image score of the input image.

14. The apparatus of claim 13, wherein, for the comparing of the marker feature with the reference marker feature of the reference marker of the one or more reference images, the one or more processors are configured to:
determine one or more patch similarity between the marker patch of the measurement image and a reference marker patch of the one or more reference images; and
determine a greatest patch similarity among the one or more patch similarities as a normal marker score of the marker.

15. The apparatus of claim 14, wherein, for the detecting of whether the anomaly is in the input image based on the comparison result of the image feature and the comparison result of the marker feature, the one or more processors are configured to perform either one of:
determining the input image as being normal in response to the normal image score satisfying a first condition based on the one or more map similarities and the normal marker score satisfying a second condition based on the least one patch similarity; and
determining the input image as being abnormal in response to the normal image score not satisfying the first condition based on the one or more map similarities or the normal marker score not satisfying the second condition based on the one or more patch similarities.

16. The apparatus of claim 10, wherein, for the generating of the reference image feature of the one or more reference images and the reference marker feature of the reference marker of the one or more reference images, the one or more processors are configured to:
generate a feature map of the one or more reference images from which the reference marker is removed by using an artificial intelligence (AI) model; and
obtain patch information of a marker patch including the reference marker in the one or more reference images.

17. A measurement system of a semiconductor manufacturing process, the measurement system comprising:
a measurement device configured to obtain a measurement image of an in-fabrication wafer and display a marker on the measurement image; and
an image inspection device configured to detect an anomaly in an input image by using an image feature and a marker feature of the input image by using an artificial intelligence (AI) model,
wherein the input image includes the measurement image and the marker and is input to the AI model from the measurement device.

18. The measurement system of claim 17, wherein the image inspection device is configured to:
compare the image feature and the marker feature of the input image with a reference image feature and a reference marker feature of a reference image; and
detect the anomaly in the input image based on comparison results.

19. The measurement system of claim 17, wherein the image inspection device is configured to:
reconstruct the measurement image by removing the marker from the input image; and
use a feature map of the reconstructed measurement image output by the AI model as the image feature.

20. The measurement system of claim 17, wherein the image inspection device is configured to:
detect the marker within the input image; and
use patch information of a marker patch of a plurality of patches as the marker feature,
wherein the marker is located in the marker patch.
